(19) United States
(12) Patent Application Publication
(10) Pub. No.: US 2010/0226506 A1
(43) Pub. Date: Sep. 9, 2010

(54) Headrest sound system

(76) Inventor: Bruce David Bayes, Trasure Island, FL (US)

Correspondence Address: Bruce David Bayes, 7199 Bryan Dary Rd., Largo, FL, 33977, US

(21) Appl. No.: 12/381,139

(22) Filed: Mar. 9, 2009

(51) Int. Cl. H04B 1/00; H04R 1/02

(52) U.S. Cl. 381/86; 381/389

(57) ABSTRACT

The inventive concept is directed to a stereo sound system consisting of an elongated sound bar which is mounted below a headrest on a wheelchair or below the headrest in a driver's seat in a vehicle. The elongated sound bar has a right and a left speaker mounted therein. The speakers receive their sound effect from either a small radio, a tape player a CD player or a cell phone. A wire connected to the elongated sound bar connects the sound bar to remotely located devices that create the sound effect. By mounting the elongated sound bar below the headrest and thereby close to the seat occupant's ears, the occupant is not deprived of any other sounds that may by important to receive. A conventional headphone covering both ears of the occupant would not be of any help in receiving those sounds.

### BACKGROUND OF THE INVENTION

The invention involves a sound system that is mounted in the vicinity of a head rest on either a wheelchair or on a headrest on a ear seat. Occupants of either a wheelchair or a ear scat have a problem listening to a portable radio, tape player CD player or even a cell phone by using headphones or earphones. The use of earphones can be problematic because such use will most likely shut out other noises such as car horns or emergency vehicle sirens. In a wheelchair, the occupant cannot hear the surrounding sound of other people in the vicinity such as warning shouts or other messages. The use of cell phones in many jurisdictions are prohibited regardless of whether a person is holding the cell phone to its ear or through he use of headphones.

### BRIEF DESCRIPTION OF THE INVENTION

The present invention alleviates the above noted problems by simply installing a stereo speaker bar in the vicinity of the headrest that is available on all wheelchairs or in automobile driver's seat. The ears of the occupant arc always in the vicinity or just below the headrest and by installing a stereo audio system in that vicinity, the occupant can always avail him or herself to the pleasure of listening to a broadcast regardless of whether the broadcast is in stereo or in monotone. The audio bar would have installed therein one speaker each of its ends or on either side of the audio bar and a wire connection would be made to a remotely located radio, tape player, CD player or cell phone. The wire would consist of a coaxial cable or wire that would carry the sound to each of the speakers in the audio bar without shutting out ail other sounds that might be of importance to either the motorist or the wheelchair occupant.

### BRIEF DESCRIPTION OF THE DRAWINGS

FIG. 1 shows an audio bar installed just below the headrest of a wheelchair;

FIG. 2 illustrates an audio bar installed below the headrest of a driver's seat.

### DETAILED DESCRIPTION OF THE INVENTION

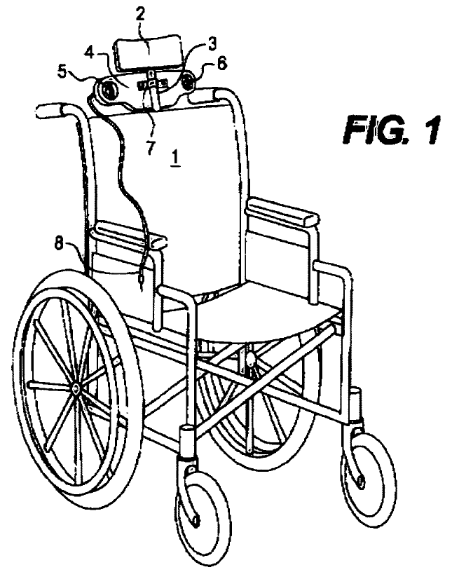

FIG. 1 illustrates a wheelchair 1 having the well known headrest 2 mounted thereon. As is also well known such headrests 2 are usually mounted by a single support bar 3 which can be adjustable in height. The elongated audio bar 4 is mounted to the support bar by way of a fastening bracket 7. The bracket 7 can take various shapes. The simplest form is a U-shaped bracket as is shown. The audio bar is mounted right under the headrest 2 but would be adjustable in height to conform to the sitting position of the occupant of the wheelchair 1 so that the right and the left ears would be as close to the right speaker 5 and the left speaker 6, respectively. The cord or wire 8 is used to plug the audio bar to connect to a radio, a tape player, a CD player or a cell phone. The respective player instruments would control the volume of the reception. It is also possible that the audio bar have batteries therein (not shown) to control the volume of the reception by way of an amplifier. However, this is not necessary because the volume control on the player instrument is sufficient to enjoy good listening. It can be seen now that any person using the wheelchair is not deprived of any other signals of importance in the vicinity of the operation of the wheelchair while enjoying the sounds emanating from the sound bar which is conveniently mounted under the headrest 2 and in the vicinity of the ears of the occupant. The connecting wire 8 can be made as a coaxial cubic so that a stereo sound can be transmitted to each of the speakers 5 and 6. If the basic instrument is not of stereo quality, the wire would deliver a monotone sound to the speaker bar.

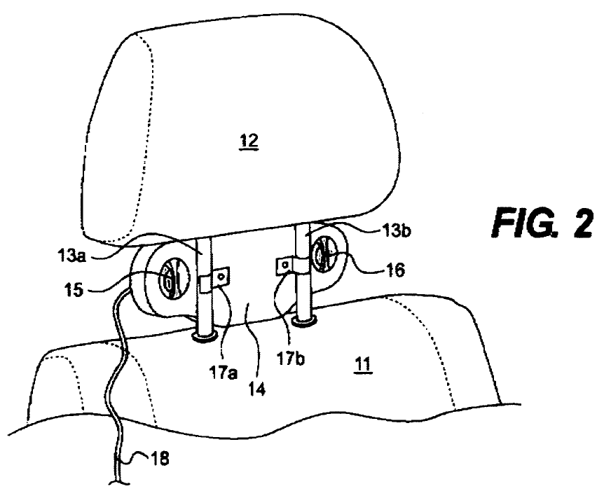

FIG. 2 illustrates the basic inventive concept, except it is applied to a driver's seat. The driver's seat is shown at 11 and the headrest is shown at 12. The headrest in a vehicle is normally supported by two height adjustable support bars 13a and 13b. The audio bar 14 is supported just below the headrest by being mounted to the two support bars 13a and 13b by way of respective clamps 17a and 17b. Again, it is advisable to adjust the height of the audio bar relative to an occupant in the seat 11 so as to be as close to the respective cars of the person sitting in the seal. The audio bar 14 in this embodiment is the same as explained in FIG. 1. The audio bar 14 has right and left speakers 15 and 16. This FIG. 2 also shows the connecting wire 18 which is to be connected to the instruments explained in FIG. 1. The advantage of mounting the audio bar 14, as explained, results in that the driver of the vehicle is not encumbered in sound by not wearing ear phones but still can hear the important signals such as warning horns or emergency vehicle sirens or even the conversation of other occupants in the vehicle.

What I claim is;

1. An audio system in combination with a scat having a headrest, said headrest is supported on a seat by at least one support bar, said system includes an elongated audio bar, means for mounting said elongated audio bar on said at least support bar just below said headrest, said elongated audio bar having a right and a left audio speaker placed therein, a wire connecting said audio bar to a remote instrument which is creating the sound.

2. The audio system of claim 1, wherein there are two support bars supporting said headrest.

3. The audio system of claim 1, wherein said audio bar has a right and a left speaker.

4. The audio system of claim 1, wherein said seat is mounted in a wheelchair.

5. The audio system of claim 1, wherein said seal is mounted in a vehicle.
